(19) United States
(12) Patent Application Publication
(10) Pub. No.: US 2023/0112504 A1
(43) Pub. Date: Apr. 13, 2023

(54) RECTIFICATION MEMBER

(71) Applicant: NIPPON FILCON CO., LTD., Tokyo (JP)

(72) Inventors: Takehiko Tatsuno, Tokyo (JP); Masahiro Yoshikawa, Tokyo (JP); Haruka Iida, Tokyo (JP)

(21) Appl. No.: 18/080,898

(22) Filed: Dec. 14, 2022

Related U.S. Application Data
(63) Continuation of application No. PCT/JP2021/000858, filed on Jan. 13, 2021.

(30) Foreign Application Priority Data
Jun. 17, 2020 (JP) 2020104795

(51) Int. Cl. D04H 3/16; D01D 5/092; F15D 1/04

(52) U.S. Cl. CPC D04H 3/16; D01D 5/092; F15D 1/04

(57) ABSTRACT

A rectification member 32 is a rectification member that rectifies air that cools molten resin filaments discharged from a nozzle, including: a multi-cylindrical part in which a plurality of cylindrical cells 34a are formed; and a wire net 36 arranged to cover an opening part of the multi-cylindrical part. The wire net 36 has a mesh opening that is smaller than the size of the cylindrical cells 34a.

### TECHNICAL FIELD

The present invention relates to a rectification member.

### BACKGROUND ART

Conventionally, a manufacturing method and a manufacturing device for spun bonded nonwoven fabrics are known in which a number of continuous filaments melt-spun from a spinning nozzle are cooled by cooling air introduced into a cooling chamber, then stretched by stretching air, and deposited on a moving collection surface (see Patent Literature 1). In this manufacturing device, a mesh for providing a rectifying effect is attached to a part where cooling air is introduced into the cooling chamber.

[Patent Literature 1] Japanese Unexamined Patent Application Publication NO. 2002-302862

### SUMMARY OF INVENTION

### Technical Problem

However, if the rectifying effect is not sufficient, variation in the fiber diameter of the nonwoven fabric and/or fiber breakage may occur. Therefore, in order to improve the quality of the nonwoven fabrics, a structure with a higher rectifying effect is required.

In this background, one of exemplary purposes of the present invention is to provide a new technology for enhancing rectifying effects.

### Solution to Problem

A rectification member according to an embodiment of the present invention is a rectification member that rectifies air that cools molten resin filaments discharged from a nozzle, including: a multi-cylindrical part in which a plurality of cylindrical cells are formed; and a wire net arranged to cover an opening part of the multi-cylindrical part. The wire net has a mesh opening that is smaller than the size of the cylindrical cells.

According to this embodiment, the rectifying effect of the air coming out of the rectification member is improved.

The wire net has a mesh count of 80 mesh or higher. This improves the rectifying effect of the air coming out of the rectification member.

The cells of the multi-cylindrical part may have a hexagonal honeycomb structure. This allows cells of the same shape to be arranged without gaps, allowing the strength of the multi-cylindrical part to be increased and also allowing the variation in the amount of air coming out from each cell to be suppressed.

The size of the cells is 2.0 mm to 6.0 mm or less. This improves the rectifying effect furthermore.

The multi-cylindrical part may be made of a stainless steel material. This allows the strength of the multi-cylindrical part to be increased. In other words, the strength of the multi-cylindrical part can be maintained even when partition walls between the cells of the multi-cylindrical part are made thinner.

The length of the cylindrical cells may be 20 mm to 50 mm in the multi-cylindrical part.

Optional combinations of the aforementioned constituting elements, and implementations of the invention in the form of methods, apparatuses, and systems may also be practiced as additional modes of the present invention.

### Advantageous Effects of Invention

According to the present invention, rectifying effects can be enhanced.

### BRIEF DESCRIPTION OF DRAWINGS

FIG. 1 is a diagram showing a schematic configuration of a manufacturing device for manufacturing nonwoven fabrics by a spun-bonding method;

FIG. 2A is a schematic diagram for explaining a schematic configuration of a rectification member according to the present embodiment; FIG. 2B is a cross-sectional view taken along A-A of the rectification member shown in FIG. 2A;

FIG. 2C is a cross-sectional view taken along B-B of the rectification member shown in FIG. 2A;

FIG. 3A is a front view of a honeycomb filter according to the present embodiment; FIG. 3B is a schematic diagram of a principal part of the honeycomb filter according to the present embodiment;

FIG. 4 is a diagram showing a model image for simulation analysis of the flow of air passing through the rectification member;

FIGS. 5A to 5D show the results of simulation analysis of rectification members in which honeycomb filters with a cell size of ¼ inch are combined with a wire net with a mesh count of 60 mesh, a wire net with a mesh count of 80 mesh, a wire net with a mesh count of 120 mesh, and a wire net with a mesh count of 200 mesh, respectively;

FIGS. 6A to 6D show the results of simulation analysis of rectification members in which honeycomb filters with a cell size of 3/16 inch are combined with a wire net with a mesh count of 60 mesh, a wire net with a mesh count of 80 mesh, a wire net with a mesh count of 120 mesh, and a wire net with a mesh count of 200 mesh, respectively;

FIGS. 7A to 7D show the results of simulation analysis of rectification members in which honeycomb filters with a cell size of ⅛ inch are combined with a wire net with a mesh count of 60 mesh, a wire net with a mesh count of 80 mesh, a wire net with a mesh count of 120 mesh, and a wire net with a mesh count of 200 mesh, respectively; and

FIG. 8 is a front view of a honeycomb filter according to a reference example.

### DESCRIPTION OF EMBODIMENTS

Hereinafter, the present invention will be explained based on embodiments with reference to the drawings. The same or equivalent constituting elements, members, and processes illustrated in each drawing shall be denoted by the same reference numerals, and duplicative explanations will be omitted appropriately. Further, the embodiments do not limit the invention and are shown for illustrative purposes, and not all the features described in the embodiments and combinations thereof are necessarily essential to the invention.

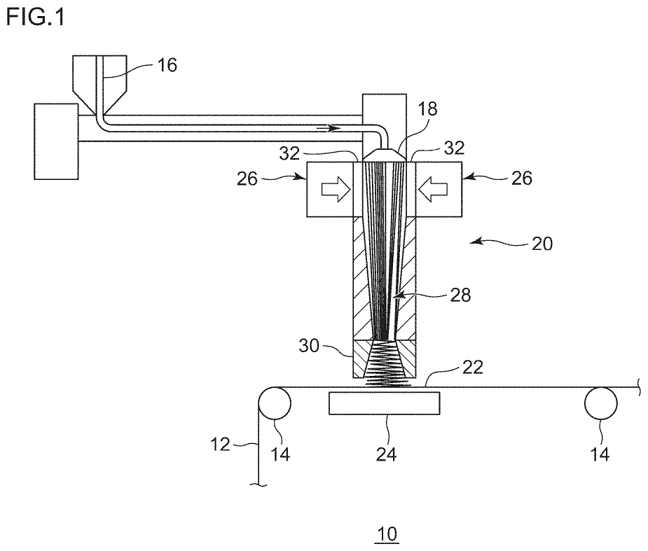

Conventionally, various methods have been devised as methods for manufacturing nonwoven fabrics, such as a spun-bonding method and a melt blow method. For example, the spun bond method is a method for manufacturing nonwoven fabrics by stretching molten resin polymers and accumulating the stretched resin polymers on a nonwoven fabric belt in the form of sheets. FIG. 1 is a diagram showing a schematic configuration of a manufacturing device for manufacturing nonwoven fabrics by a spun-bonding method.

A nonwoven fabric manufacturing device 10 shown in FIG. 1 includes an endless nonwoven fabric belt 12, a plurality of drive rollers 14 that support and drive the nonwoven fabric belt 12, a discharging device 20 that discharges a molten resin polymer 16 from a spinning nozzle 18 onto the nonwoven fabric belt 12 in the form of spun and drawn molten resin filaments, and a suction device 24 that sucks a web 22 in which the resin filaments discharged onto the nonwoven fabric belt 12 are deposited as a fibrous aggregate from the back side of the nonwoven fabric belt 12.

The discharging device 20 includes an air blower 26 that blows air to cool the resin filaments discharged from the aforementioned spinning nozzle 18, a drawing unit 28 that draws the cooled resin filaments, and an ejector 30 that discharges the spun and drawn resin filaments. The air blower 26 has a pair of rectification members 32 for rectifying the air to be blown. The pair of rectification members 32 are arranged such that the air blow ports face each other. The air velocity in the air blower 26 is 0.5 to 1.3 m/s, and the temperature of the blown air is room temperature (20 to 30 degrees Celsius).

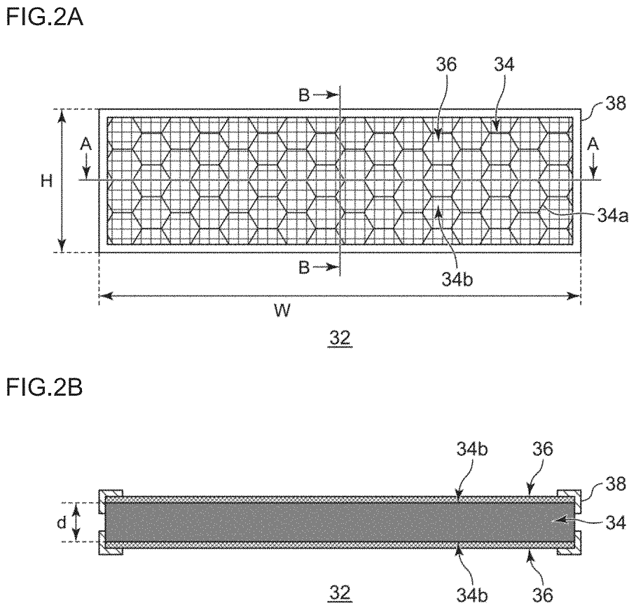

FIG. 2A is a schematic diagram for explaining a schematic configuration of a rectification member according to the present embodiment. FIG. 2B is a cross-sectional view taken along A-A of the rectification member shown in FIG. 2A. FIG. 2C is a cross-sectional view taken along B-B of the rectification member shown in FIG. 2A. The sizes and specifications of each part of the rectification members shown in FIGS. 2A to 2C have been scaled down for easier understanding and are not necessarily as shown in the figures.

A rectification member 32 is a member that rectifies the air that cools the molten resin filaments discharged from the spinning nozzle 18, a honeycomb filter 34 serving as a multi-cylindrical part in which a plurality of cylindrical cells 34a are formed, a pair of wire nets 36 arranged to cover front and back opening parts 34b of the honeycomb filter 34, and a frame member 38 that integrates the stacked honeycomb filter 34 and wire nets 36.

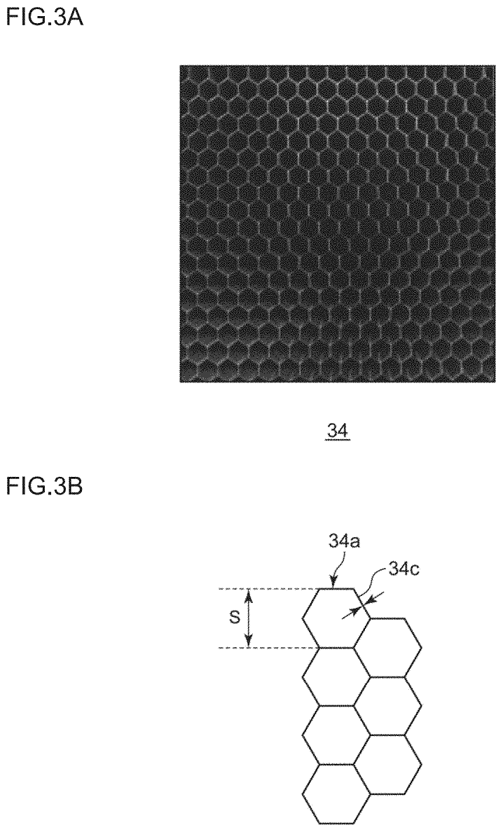

FIG. 3A is a front view of a honeycomb filter according to the present embodiment. FIG. 3B is a schematic diagram of a principal part of the honeycomb filter according to the present embodiment. As shown in FIG. 3A, the honeycomb filter 34 includes hexagonal (hexagonal cylindrical) cells 34a whose top and bottom faces are open and that are arranged vertically and horizontally without gaps. The size S of the cells 34a is smaller than 6.35 mm (¼ inch) and is rather 6.0 mm or less and preferably 5.0 mm or less. This increases the strength of the entire honeycomb filter 34 and suppresses deformation of the cells 34a.

The honeycomb filter 34 is made of a stainless steel material. This allows the strength of the honeycomb filter 34 to be increased. In other words, the strength of the honeycomb filter 34 can be maintained even when partition walls 34c between the cells 34a of the honeycomb filter 34 are made thinner. In addition to a stainless steel material, a material with a Young's modulus of 100 [GPa] or higher, preferably 150 [GPa] or higher, and more preferably 200 [GPa] or higher may be used.

The partition walls 34c between the cells 34a have a thickness of 0.02 to 0.10 mm, and as long as the deformation of the cell 34a can be suppressed, the thinner the better. By making the partition walls thinner, the pressure loss during the air blowing can be reduced. The size S of the cell 34a is preferably 2.0 mm or larger, and the length d of the cells 34a (see FIG. 2B) is preferably in the range of 20 to 50 mm. This allows the pressure loss during the air blowing to be suppressed.

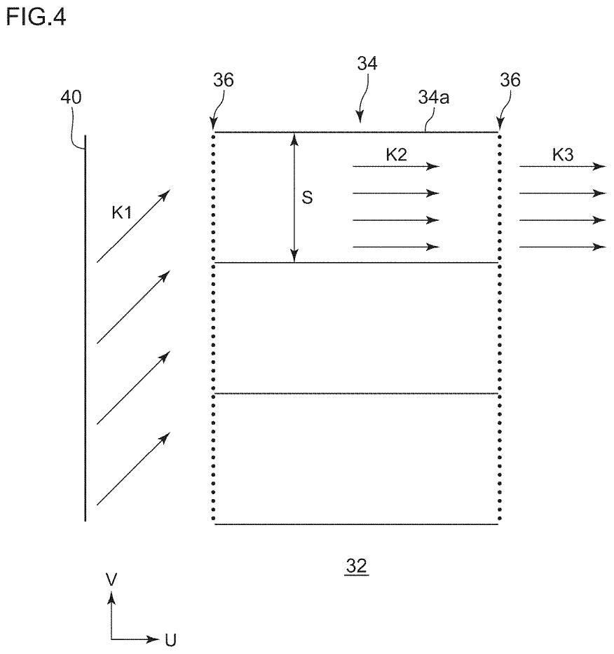

Next, the effect of the size S of the cells 34a and the mesh count (the number of meshes) of the wire nets 36 on the rectifying effect will be explained. FIG. 4 is a diagram showing a model image for simulation analysis of the flow of air passing through a rectification member 32. Flowsquare 4.0, which is two-dimensional fluid analysis software, was used for the simulation analysis.

As shown in FIG. 4, in the rectification member 32, a wire net 36 is arranged covering the openings on the inlet and outlet sides of the honeycomb filter 34. As an analysis condition, air sent from a blower device flows in at an angle (arrow K1) from an inlet 40 of the discharging device 20, passes through a mesh net 36 on the inlet side and proceeds through the inside of each cell 34a of the honeycomb filter 34 (arrow K2), and flows out through a wire net 36 on the outlet side (arrow K3). Here, the flow of the air entering from inlet 40 was defined as a vector of 3 m/s in a horizontal direction U and 2 m/s in a vertical direction V.

Regarding the number of the cells of the honeycomb filter in the simulation, there were three cells in the vertical direction when the size S of the cells was 6.35 mm (¼ inch), four cells in the vertical direction when the size S of the cells was 4.7625 mm ( 3/16 inch), and six cells in the vertical direction when the size S of the cells was 3.175 mm (⅛ inch). Further, four types of mesh counts, 60 mesh, 80 mesh, 120 mesh, and 200 mesh, were used for the wire net 36. Then, simulation analysis was performed for each of rectification members in which the three types of honeycomb filters with different cell sizes S and the four types of wire nets with different mesh counts were combined.

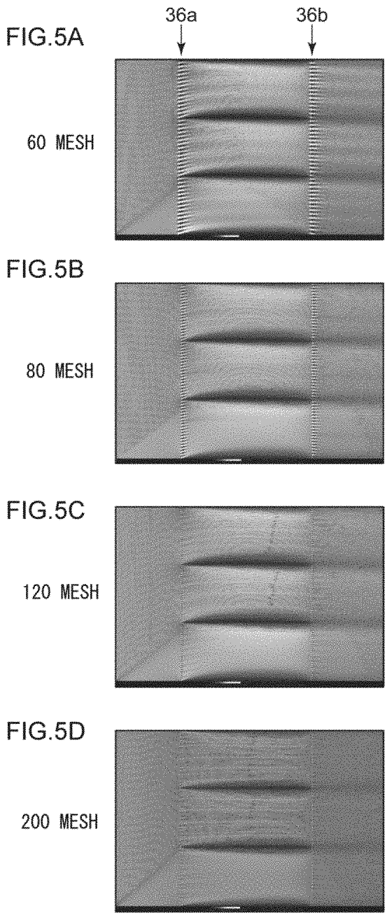

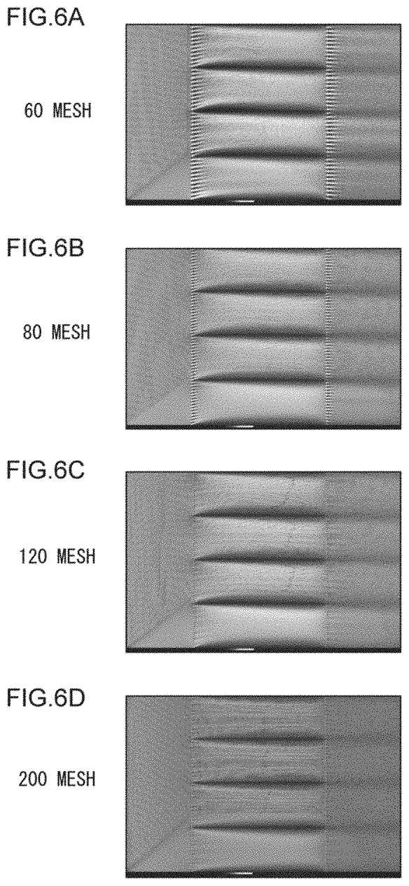

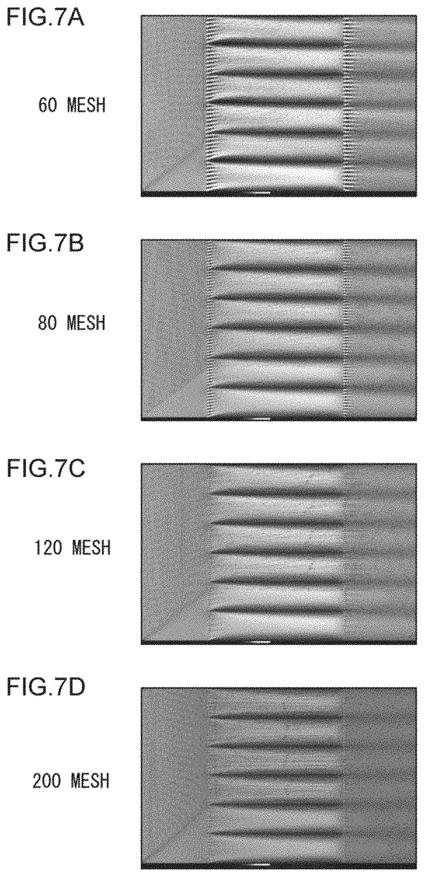

FIGS. 5A to 5D show the results of simulation analysis of rectification members in which honeycomb filters with a cell size of ¼ inch are combined with a wire net with a mesh count of 60 mesh, a wire net with a mesh count of 80 mesh, a wire net with a mesh count of 120 mesh, and a wire net with a mesh count of 200 mesh, respectively. FIGS. 6A to 6D show the results of simulation analysis of rectification members in which honeycomb filters with a cell size of 3/16 inch are combined with a wire net with a mesh count of 60 mesh, a wire net with a mesh count of 80 mesh, a wire net with a mesh count of 120 mesh, and a wire net with a mesh count of 200 mesh, respectively. FIGS. 7A to 7D show the results of simulation analysis of rectification members in which honeycomb filters with a cell size of ⅛ inch are combined with a wire net with a mesh count of 60 mesh, a wire net with a mesh count of 80 mesh, a wire net with a mesh count of 120 mesh, and a wire net with a mesh count of 200 mesh, respectively. In each figure, a wire net 36a on the inlet side and a wire net 36b on the outlet side have the same mesh count. In each figure, white areas have relatively high flow velocity, and black areas have relatively low flow velocity.

As shown in FIGS. 5A, 6A, and 7A, when the mesh count of the wire net 36b on the outlet side is 60 mesh, the velocity of the flow of the air flowing out from the wire net 36b in a streaky pattern is uneven regardless of the cell size. In other words, the streaky areas are long-drawn, and there is room for improvement in the air rectification effect. On the other hand, as shown in FIGS. 5B, 6B, and 7B, etc., when the mesh count of the wire net 36b is 80 mesh or larger, unevenness in the velocity of the flow of the air flowing out from the wire net 36b in a streaky pattern becomes smaller as the number of meshes becomes larger. Thus, when the wire net 36a and the wire net 36b have a mesh count of 80 mesh or more, the rectification effect of the air coming out of the rectification member is improved.

The mesh opening [mm] when the mesh count is 60 mesh is represented as follows: (25.4 mm/60)−wire diameter [mm], where the wire diameter is in the range of 0.05 to 0.20 mm. The wire nets 36 according to the present embodiment has a mesh opening that is smaller than the size S of the cylindrical cells. Therefore, the rectifying effect of the air coming out of the rectification member is improved.

Since the honeycomb filter 34 according to the present embodiment has a hexagonal honeycomb structure of the cells 34a, cells of the same shape can be arranged without gaps, allowing the strength of the honeycomb filter 34 to be increased and also allowing the variation in the amount of air coming out from each cell 34a to be suppressed.

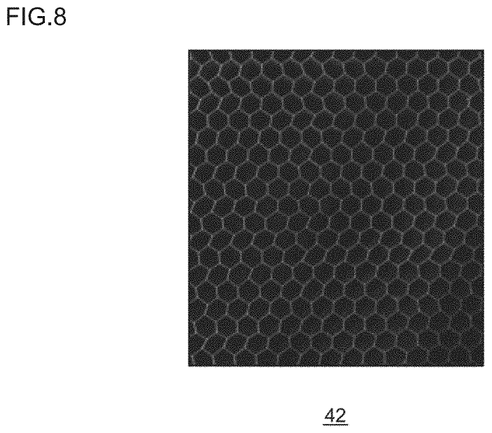

Next, the effect of the material and the size of the cells of the honeycomb filter on the strength will be explained. FIG. 8 is a front view of a honeycomb filter according to a reference example. A honeycomb filter 42 shown in FIG. 8 is made of an aluminum material, and the size S of the cells thereof is ¼ inch. As shown in FIG. 8, the shape of the hexagonal opening part of each cell varies in this honeycomb filter 42. Therefore, this affects the uniformity of the air delivered from a rectification member provided with the honeycomb filter 42.

The height H of the rectification members 32 according to the present embodiment (see FIG. 2B) may be in the range of 500 to 1000 mm or in the range of 600 to 800 mm. The width W of the rectification members 32 (see FIG. 2B) may be in the range of 4000 to 5000 mm or in the range of 4500 mm to 4800 mm. Regarding the cells of the multi-cylindrical part, the shape is not limited to a regular hexagonal cylinder, and an array of one or more types of polygonal cylinders such as square cylinders may be employed, or cylinders may be employed.

As described above, in the rectification members 32 according to the present embodiment, the mesh of the wire nets 36 is finer, and the honeycomb filter 34 has a finer and more uniform structure so as to improve the rectification effect. As a result, effects can be obtained such as making the diameter of the resin filaments that become nonwoven fibers of the web 22 smaller and more uniform for fibrillization, preventing fiber breakage, and preventing fibers from accumulating and clumping together and then falling (dropping) onto a nonwoven fabric.

While the invention has been described by referring to the above-described embodiment, the invention is not limited to the above-described embodiment, and the appropriate combination of the configurations of the embodiment or the substitution thereof is also included in the invention. Further, the combination of the embodiments or the process sequence thereof may be appropriately set or various modifications in design may be added to the embodiments based on the knowledge of the person skilled in the art. An embodiment having such modifications may be also included in the scope of the invention.

### INDUSTRIAL APPLICABILITY

The present invention can be used for manufacturing devices for nonwoven fabrics.

### REFERENCE SIGNS LIST

10 nonwoven fabric manufacturing device, 16 resin polymer, 18 spinning nozzle, 20 discharging device, 26 air blower, 28 drawing unit, 30 ejector, 32 rectification member, 34 honeycomb filter, 34a cell, 34b opening part, 34c partition wall, 36, 36a, 36b wire net

1. A rectification member that rectifies air that cools molten resin filaments discharged from a nozzle, comprising:
a multi-cylindrical part in which a plurality of cylindrical cells are formed; and
a wire net arranged to cover an opening part of the multi-cylindrical part, wherein
the wire net has a mesh opening that is smaller than the size of the cylindrical cells.

2. The rectification member according to claim 1, wherein the wire net has a mesh count of 80 mesh or higher.

3. The rectification member according to claim 1, wherein the cells of the multi-cylindrical part have a hexagonal honeycomb structure.

4. The rectification member according to claim 3, wherein the size of the cells is 2.0 mm to 6.0 mm or less.

5. The rectification member according to claim 3, wherein the multi-cylindrical part is made of a stainless steel material.

6. The rectification member according to any one of claim 1, wherein the length of the cylindrical cells is 20 mm to 50 mm in the multi-cylindrical part.

7. The rectification member according to any one of claim 3, wherein the length of the cylindrical cells is 20 mm to 50 mm in the multi-cylindrical part.

8. The rectification member according to any one of claim 4, wherein the length of the cylindrical cells is 20 mm to 50 mm in the multi-cylindrical part.

9. The rectification member according to any one of claim 5, wherein the length of the cylindrical cells is 20 mm to 50 mm in the multi-cylindrical part.
